(19) United States
(12) Patent Application Publication
(10) Pub. No.: US 2026/0287014 A1
(43) Pub. Date: Sep. 24, 2026

(54) INNER RING FOR A SELF-ALIGNING ROLLER BEARING

(71) Applicant: AKTIEBOLAGET SKF, GOTEBORG (SE)

(72) Inventors: Bo Niclas THIM, Olofstorp (SE); Lars Eric Mikael STIGSJÖÖ, Angered (SE); Eduardo Daniel ORTEGA PERDOMO, Göteborg (SE); Peter FRIJLINK, Kode (SE)

(21) Appl. No.: 19/168,105

(22) PCT Filed: Mar. 31, 2023
(86) PCT No.: PCT/EP2023/058439

§ 371 Date: Sep. 23, 2025

(51) Int. Cl. F16C 23/08; F16C 33/58; F16C 33/78

(52) U.S. Cl. CPC F16C 23/086; F16C 33/585; F16C 33/7806; F16C 33/7856

(57) ABSTRACT

An inner ring for a self-aligning roller bearing has a rotational center axis, a raceway configured to receive roller elements and a retaining flange at a first axial side of the raceway. The retaining flange has a flange width and a filling slot to allow the insertion of the roller elements. The inner ring has a first axial end face and a seal surface having a first end at the first axial end face and a seal surface connecting end at the retaining flange. The seal surface is a counter surface for a sealing lip, and the seal surface has a seal surface width. The retaining flange together with the seal surface forms a raceway connecting portion that has a raceway connecting portion width, and the flange width is 19-35 % of the raceway connection portion width.

### CROSS-REFERENCE

This application is the U.S. National Stage of International Application No. PCT/EP2023/058439 filed on Mar. 31, 2023.

### TECHNICAL FIELD

The present disclosure is directed to an inner ring for a self-aligning roller bearing. The present disclosure also concerns a self-aligning roller bearing. The present disclosure further concerns a method for manufacturing an inner ring for a self-aligning roller bearing and a method for manufacturing a self-aligning roller bearing.

### BACKGROUND OF THE INVENTION

Self-aligning roller bearings are known for their ability to handle demanding applications where the loads are high and where shaft deflections also can be expected. In fact, by using rollers instead of balls, larger loads can be accommodated. Moreover, the self-aligning capability, i.e., the capability of the bearing's inner and outer rings to be relatively misaligned, protects the bearing from internal stresses caused by shaft deflections, and therefore the bearing's service life may not be negatively affected by such deflections.

There are different types of self-aligning roller of the most common types may be the spherical roller bearing which comprises two rows of symmetrical rollers, a common sphered outer ring raceway and two inner ring raceways inclined at an angle to the bearing axis. The center point of the sphere in the outer ring raceway is at the bearing axis. There are also other types of self-aligning roller bearings. Such other examples include the spherical roller bearing which has two rows of asymmetrical rollers, and the toroidal roller bearing which comprises one row of rollers and where the bearing can accommodate both shaft deflections and axial shaft displacements.

It is also known to provide self-aligning roller bearings with seals for sealing off the openings between the inner and the outer ring. Such seals may be provided on the outside of the axial side face of the bearing or they may be integrated such that the seal is located between the bearing's rings without extending axially outside the bearing's perimeter. An advantage with sealed bearings is that they prevents foreign matter from entering the bearing's inside, and also, they may be used for accommodating lubricant, such as grease. The sealing function is generally provided by the use of a circumferentially extending sealing lip made of rubber, which is in contact with either the inner or the outer ring.

Self-aligning roller bearings often comprises a retaining flange to help prevent the rollers from rolling out from the bearing. The retaining flange needs to be high enough to prevent rollers from falling out, yet low enough to allow for assembly of rollers between the bearing rings when assembling the bearing. A filling slot is often used to aid in the assembling the bearing. The inner ring design and the required height of the retaining flange may vary depending on the design of the ring and the application's loading conditions. Further, having cages with different cage pocket freedom for allowing the roller to align and steer depending on loading conditions put demands on existing bearing design rules. The design rules may be inadequate to simulate existing conditions and how the roller may move in every situation, thereby over or under dimensioning the flange height. Further, the design of the inner ring is different if it is a sealed or open bearing, causing reduction in efficiency during production of the rings.

### SUMMARY

In view of the above, a first aspect of the present disclosure is to provide an improved inner ring for a self-aligning roller bearing, which to at least some extent overcomes some of the issues of the prior art. A further aspect of the disclosure is to provide an improved self-aligning roller bearing. A yet further aspect is to provide an improved method for manufacturing an inner ring for a self-aligning roller bearing, and a method for manufacturing an improved self-aligning roller bearing.

The inner ring for a self-aligning roller bearing comprises:
a rotational center axis,
a raceway for receiving roller elements,
a retaining flange provided on a first axial side of the raceway, the retaining flange being configured to prevent roller elements from falling out from a first axial opening between the inner and an outer ring of a roller bearing comprising the inner ring, and the retaining flange presents a flange width,
a filling slot provided on the retaining flange, the filling slot configured to allow roller elements to be inserted between the inner ring and the outer ring during assembly of the roller bearing,
a first axial end face,
a seal surface connecting the first axial end face in one end and the retaining flange at a seal surface connecting portion of the seal surface at an opposite end, the seal surface configured to receive a sealing lip, and the seal surface presents a seal surface width,
a raceway connecting portion comprising the retaining flange and the seal surface and the raceway connection portion (6) presents an axial distance, and
the flange width is 19-35 % of the axial distance of the raceway connecting portion, preferably 21-33 %.

Given the ability of the spherical roller bearing to accommodate misalignment and/or significant shaft deflection, it is one cognition of this invention accompanied by extensive research and testing that the ratio of the flange width to the axial distance of the raceway connecting portion is crucial to ensure the longest possible bearing life. The service life of the bearing is influenced, among other things, by the sealing function, which must be maintained for the entire angular adjustability of the bearing with the longest possible seal service life, as well as by the design of a potential interaction between the outer roller faces and the flange and by other factors. Thereby the ratio of the flange width to the axial distance of the raceway connecting portion in the range from 19-35 % in particular in the range from 21-33 % ensures good to very good results. Another benefit of this selection is that the retaining flange is both strong enough to handle loads of an open SRB, while providing enough axial distance between the rollers and the seal to prevent the rollers from coming in contact with the seals during misalignment in case of a sealed SRB.

Accompanied by this, the seal surface width may be between 65-81 % of the axial distance of the raceway connecting portion, preferably between 67-79 %. To have a seal surface width according to this, ensures enough sealing surface for a seal to seal against also during misalignments.

Optionally, the raceway connecting portion has a first radius and the retaining flange has a flange radius from the rotational center axis. The flange radius is equal to or between 100.2% and 103.7% of the first radius, preferably equal to or between 101% and 103% of the first radius of the raceway connecting portion. Optionally, the flange radius may be around 102% of the of the first radius of the raceway connecting portion. With this, an improved inner ring is provided in which the flange radius has been defined in relation to a raceway connecting portion of the retaining flange. In particular it has been realized that by providing a retaining flange having a flange radius higher than 100.2% but lower than 103.7% of the first radius of the raceway connecting portion, an inner ring that can reliably contain the roller elements during bearing operation is achieved, while providing enough play to efficiently assemble the bearing when inserting the rollers in between the inner and outer rings. Further, the bearing containing the inner ring according to the invention can be remanufactured and serviced in a safe manner, as the retaining flange is more efficiently preventing the rollers from falling out of the bearing unexpectedly.

Further, the inventors have realized that by providing an inner ring as described herein, the same ring design can be used for both sealed and open bearings, reducing complexity in the production of the rings. By an open bearing is meant a bearing without seals. By sealed bearing is meant a bearing with seals, covering at least partly the radial gap between the inner and outer ring. The present disclosure also provides a user with an ability to convert an at present open bearing into a sealed bearing, without the need of buying a new bearing, or significantly amend the existing one. This reduces the cost also for the user.

In this document the self-aligning roller bearing will be referenced as a double roller row spherical roller bearing in the figures and/or simply as a spherical roller bearing (SRB) in the examples given be below. The disclosure is though suitable for other self-aligning roller bearings comprising a retaining flange. These spherical roller bearings may be, but not limited to, for example single roller row SRBs, angular contact SRBs, toroidal roller bearings, angular contact toroidal roller bearings, or bearing arrangements comprising a combination thereof.

The terms “roller elements” and “rollers” are used in this document. For the sake of clarity, both terms refer to the same thing, i.e., the rolling elements of a self-aligning roller bearing.

When self-aligning roller bearings are exposed to misalignment, for instance due to shaft deflections in the application in which it is installed, the rollers may be pushed to go outside of the normal path on raceways. As such, a retaining flange is needed to keep the rollers in place during operation. In an SRB, the outer ring is usually made by a big round raceway onto which the rollers can roll more freely to take up the misalignment from the shaft. The inner ring, in the case of a double roller row SRB, often has two distinct raceways where the roller rows are separated from each other by a cage and/or a guiding ring and kept inside of the bearing by using the retaining flanges on each axial outer side of the bearing. Open bearings can commonly tolerate a misalignment of more than 3.5 degrees. At that point, parts of the rollers are outside of the outer ring raceways. The rollers are even axially outside of one of the two axial end faces of the bearing, depending on the present misalignment the bearing need to compensate for. At that situation, a lot of force is applied by the rollers to the retaining flange. If the retaining flange is not high enough, the rollers may end up sliding up onto the retaining flange, risking deforming both the retaining flange and the roller, thereby reducing bearing life. The rollers risk to fall out from the bearing entirely, causing safety issues for operators and malfunctioning of the bearing and the application in which it is installed.

Similarly, a sealed SRB (SSRB) is suitable for applications that are not expected to be exposed to as high misalignment. An SSRB can typically 0.5 to 0.85 degrees misalignment. This can be compared to an open SRB that can often handle more than 3.5 degrees as mentioned above. This is due to that the rollers otherwise would push away and deform the seals. As the SSRB is not exposed to as much misalignment, it does not require as high retaining flange to keep the rollers in place. Further, the thickness of the retaining flange can be reduced as it is not exposed to as high forces. Instead, a seal surface can be provided for receiving a seal, while still be within the dimension of an open SRB, thereby fulfilling any ISO-standard dimension as for the open SRB.

A problem is that two different types of inner rings are needed depending on if it is an open or sealed SRB. As explained above, the inventors have realized that by providing an inner ring according to the disclosure, the same ring design can be used for both sealed and open bearings, reducing complexity in the production of the rings. The disclosure also provides a user with an ability to convert an at present open bearing into a sealed bearing, without the need of buying a new bearing, or significantly amend the existing one. This reduces the cost also for the user of the bearing.

The inventors have realized that if the retaining flange radius is larger than 103.7% of the first radius of the raceway connecting portion, the bearing becomes too difficult to assemble. If the flange radius is lower than 100.2% of the first radius of the raceway connecting portion, then the retaining flange does not provide enough support for the rollers, especially not when the bearing is an open self-aligning bearing. Further, the bearing does not reliable maintain the rollers during assembly of the bearing, or when remanufacturing the bearing, or when for instance handling the bearing when converting it from an open SRB into a sealed SRB. By providing an inner ring where the flange radius is equal to or between 102.2% and 103.7% of the first radius, preferably equal to or between 101% and 103% of the first radius (R1), then a both safe and cost-efficient to assemble bearing can be provided. Also, a multi-purpose ring is provided, suitable for both open and sealed self-aligning roller bearings.

In this document, the expressions “axial” and “radial” are used. Unless expressed otherwise, axial refers to an axial extension of the inner ring which is parallel to the center/rotation axis of the inner ring. Radial refers to an extension of the inner ring which is perpendicular to the axial extension. By for instance radially lower or radially higher is meant things being on different radial distance from the rotational center, with the radially higher one having a larger radial distance, and vice versa. By “axially inside” or “axially outside” is meant is meant how things are related to each other in view of an axial center axis, with radially inside having a lower axial distance, and vice versa.

By raceway connecting portion is meant a portion of the retaining flange that the raceway connects to. Often, there is a rounded chamfer or groove between the raceway and the retaining flange to provide for a better internal load distribution in the ring. In this case, the raceway contacting portion should be defined by the axial extension of the raceway when seen in in a cross-sectional view. Either way, the raceway contacting portion is the radially lowest portion of the flange that the rollers come into contact with during normal running conditions.

Optionally, the filling slot is a part-circular cut out extending from a top surface of the retaining flange and extending to a filling slot radius from the rotational center axis, wherein the filling slot radius is equal to or between 100.1% and 103.5% of the first radius (R1) of the raceway connecting portion (6). This further supports easy assembly of the bearing.

By top surface is meant from the radially outermost surface of the retaining flange.

Optionally, the inner ring has an axial center axis and a ring width extending from the axial center axis to the first axial end face of the ring. The raceway connecting portion has an axial distance from the first axial end face, wherein the axial distance is equal to or between 14-16% of the ring width, preferably around 15% of the ring width of the ring width. This enables to fit both a retaining flange and a seal surface that fulfill the requirements of the bearing in terms of taking up possible loads and misalignments, and still providing enough space to provide for a seal that can seal properly at the seal surface.

According to a further aspect of the disclosure, a self-aligning roller bearing is provided.

The self-aligning roller bearing comprising:
an inner ring,
an outer ring located radially outside of the inner ring, the inner and outer ring presenting a first axial opening therebetween,
roller elements positioned between and being in rolling contact with the inner and outer rings, and
a cage for retaining the roller elements,

where inner ring of the self-aligning roller bearing ring is an inner ring according to any of the embodiments mentioned herein. This provides for a bearing that has a good running performance and that is easy to assemble, yet safe to handle as it efficiently prevents the rollers from falling out during assembly/disassembly.

Optionally, the cage is a crown type cage. It has namely been realized that the disclosure is particularly beneficial for bearings with this type of cage, as crown type cages allows for more roller freedom, thereby making the height of the retaining flange increasingly important to retain the rollers.

Optionally, the self-aligning roller bearing is a sealed self-aligning bearing further comprising a seal extending from the outer ring to the seal surface, thereby sealing the first axial opening. This provides for a bearing more resistant to contamination from outside debris. It further provides and increased ability to retain lubricant inside of the bearing.

According to a yet further aspect of the disclosure, a method for manufacturing an inner ring for a self-aligning roller bearing is provided. The inner ring comprising:
a rotational center axis,
a raceway for receiving roller elements,
a retaining flange provided on a first axial side of the raceway, the retaining flange being configured to prevent roller elements from falling out from a first axial opening between the inner and an outer ring of a roller bearing comprising the inner ring. The retaining flange shows a flange width. A filling slot is provided on the retaining flange. The filling slot is configured for allowing roller elements to be inserted between the inner ring and the outer ring during assembly of the roller bearing. The inner ring further comprises a first axial end face and a seal surface connecting the first axial end face in one end and the retaining flange at a seal surface connecting portion of the seal surface at an opposite end. The seal surface is configured for receiving a sealing lip and the seal surface shows a seal surface width. A raceway connecting portion consists of the retaining flange and the seal surface and the raceway connection portion presents an axial distance.

The method comprises steps of:
providing the inner ring, and
further providing the flange width being 19-35 % of the axial distance of the raceway connecting portion, preferably 21-33 %.

According to a yet further aspect of the disclosure, a method for manufacturing a self-aligning roller bearing is provided. The method comprising steps of:
providing an outer ring, roller elements and a cage for retaining the roller elements,
further providing an inner ring according to any of the embodiments mentioned herein,
optionally providing a seal extending from the outer ring to a seal surface of the inner ring, thereby sealing the first axial opening.

This method provides the option to provide the seal at a later stage and make the open bearing onto a sealed one, without changing the inner ring.

Optionally, the method includes a step of providing a groove on the outer ring for each seal to be fitted. Thus, the outer ring may be without grooves initially to allow for a longer outer ring raceway to take up displacement of the roller due to misalignment, grooves that are later provided to the outer ring in case of optionally providing the seals. The seal surface to receive the seal is places axially outside of the filling slot.

By the provision of the above-mentioned design, an improved self-aligning roller bearing may be provided having improved sealing performance. More particularly, by providing the seal surface as specified herein in respect of the at least one filling slot, sealing will be effectuated in the complete circumference between the first sealing ring element and the inner bearing ring element. Thereby, an improved sealing performance may be provided for the roller bearing comprising the at least one filling slot. Hence, the present disclosure provides high sealing performance, good running performance due to the retaining flange and facilitated assembly/disassembly of the bearing due to the at least one filling slot. The improved sealing performance may prevent contaminants/debris from entering the bearing, and it may additionally prevent lubricant, such as grease or oil, from leaking out from the bearing.

Optionally, the sealing mating surface may further be located radially inside the at least one filling slot. By further locating the sealing mating surface radially inside the location of the filling slot, a further facilitated assembly/disassembly of the bearing may be effectuated while also maintaining the improved sealing performance. With “radially inside” is herein meant that the sealing mating surface is located at a radial distance from the rotational center axis of the roller bearing which is smaller than a radial distance from the rotational center axis of the roller bearing to the at least one filling slot.

Optionally, the roller bearing may further be configured such that at least one of the roller elements may only be inserted between the bearing rings via the at least one filling slot in order to completely assemble the roller bearing.

Optionally, the roller bearing is a large roller bearing with an outer diameter of 1000 millimeters (mm) or more. Still optionally the roller bearing is a large roller bearing with an outer diameter of 1100, 1200, 1300 or 1400 millimeters or more. It has namely been realized that the disclosure is advantageous for larger bearings since larger bearings may preferably be provided with a filling slot for facilitating the assembly/disassembly operation.

Optionally, the inner bearing ring element may further comprise a second retaining flange provided on a second axial side being located on an axially opposite side to the first axial side of the self-aligning roller bearing. Still optionally, the second retaining flange may be configured for preventing the roller elements from falling out from the roller bearing from a second axial opening between the inner and the outer bearing ring elements at the second axial side. Still further, the roller bearing may further comprise a second sealing ring element located at the second axial side for sealing the second axial opening, wherein the second sealing ring element is rotatable in relation to the inner bearing ring and seals against a second sealing mating surface of the inner bearing ring. Moreover, the second retaining flange may comprise at least one filling slot configured for allowing the roller elements to be inserted in-between the inner and the outer bearing ring elements via the at least one filling slot during assembly of the roller bearing, and the second sealing mating surface being located axially outside the at least one filling slot.

### BRIEF DESCRIPTION OF THE DRAWINGS

The present disclosure will hereinafter be further explained by means of non-limiting examples with reference to the appended schematic figures where;

FIG. 1 is a cross-sectional view of a portion of an inner ring according to an exemplary embodiment of the present disclosure;

FIG. 2 is a cross-sectional view of a portion of an inner ring according to an exemplary embodiment of the present disclosure;

FIG. 3 is a cross-sectional view of a portion of an inner ring according to an exemplary embodiment of the present disclosure;

FIG. 4 is a cross-sectional view of self-aligning roller bearing according to an exemplary embodiment of the present disclosure;

FIG. 5 is a cross-sectional view of a sealed self-aligning roller bearing according to an exemplary embodiment of the present disclosure;

FIG. 6 is a cross-sectional view of a self-aligning roller bearing according to prior art;

FIG. 7 is a cross-sectional view of a sealed self-aligning roller bearing according to prior art;

FIG. 8 is a flowchart of a method for manufacturing an inner ring according to an exemplary embodiment of the present disclosure; and

FIG. 9 is a flowchart of a method for manufacturing a self-aligning roller bearing according to an exemplary embodiment of the present disclosure.

It should be noted that the drawings have not necessarily been drawn to scale and that the dimensions of certain features may have been exaggerated for the sake of clarity.

### DETAILED DESCRIPTION OF PREFERRED EMBODIMENTS

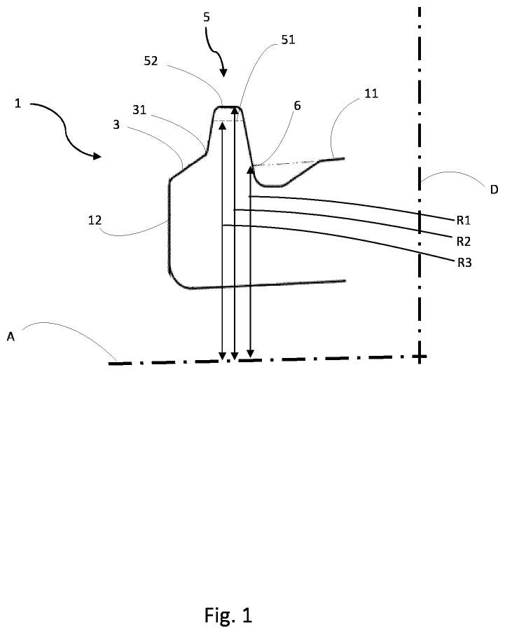

FIG. 1 depicts a cross-sectional view of a portion of an inner ring 1 according to an exemplary embodiment of the present disclosure. The cross-sectional view is defined by a plane which extends along a rotational center axis A of the inner ring 1.

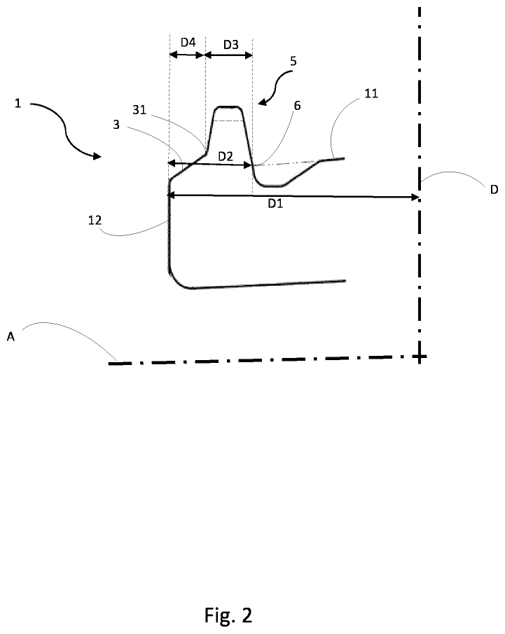

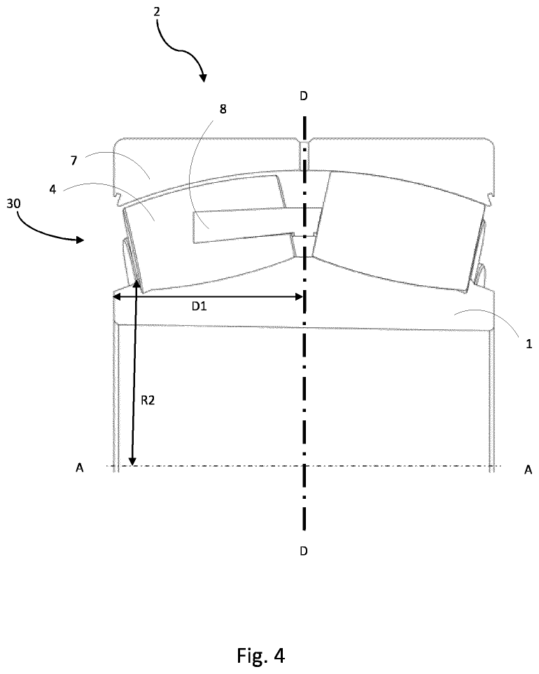

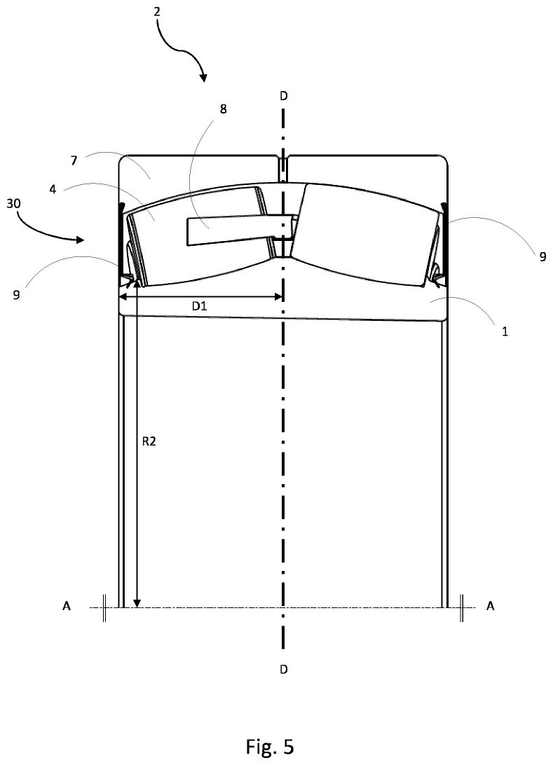

The inner ring 1 for a self-aligning roller bearing 2 is shown. The inner ring 1 for a self-aligning roller bearing 2 comprises a rotational center axis A, a raceway 11 for receiving roller elements 4, and a retaining flange 5 provided on a first axial side of the raceway 11. The retaining flange 5 is configured to prevent roller elements from falling out from a first axial opening 30 between the inner and an outer ring 7 of a roller bearing 2 comprising the inner ring 1 (not shown see, FIGS. 4 and 5). A filling slot 51 is provided on the retaining flange 5. The filling slot 51 extends from a top surface 52 of the retaining flange 5 that is configured to allow roller elements 4 to be inserted between the inner ring 1 and the outer ring 7 during assembly of the roller bearing 2 (not shown, see FIGS. 4 and 5). The inner ring 1 further comprises a first axial end face 12 and a seal surface 3 connecting the first axial end face 12 at one end and the retaining flange 5 at a seal surface connecting portion 31 at an opposite end. The seal surface 3 is configured to receive a sealing lip (FIG. 5). The retaining flange 5 has a flange width (D3, FIG. 2) defined by an axial distance between the seal surface connecting portion 31 and a raceway connecting portion 6. The raceway connecting portion 6 has first radius R1 and the retaining flange 5 has a flange radius R2 from the rotational center axis A. The filling slot 51 has a filling slot radius R3 from the rotational center axis A. Further, an axial center axis D can be seen. The axial center axis D is in the axial center plane of the inner ring 1. In FIGS. 1-3, showing a portion of the inner ring 1, this reference may appear offset. A more dimensionally accurate display of the axial center axis D can be seen in FIG. 4-5 showing the inner ring 1 in relation to a complete bearing 2 according to the disclosure.

The flange radius R2 and the first radius R1 are located at axially opposite ends of the raceway connecting portion 6. The flange radius R2 is equal to or between 100.2% and 103.7% of the first radius R1, preferably equal to or between 101% and 103% of the first radius R1 of the raceway connecting portion 6.

FIG. 2 is a cross-sectional view of a portion of an inner ring 1 according to an exemplary embodiment of the present disclosure, as presented in FIG. 1. Here a more detailed view of the portion of the inner ring 1 can be seen in relation to the axial center axis D is in the axial center of the inner ring 1.

Here, the inner ring 1 is shown having a ring width extending from the axial center axis D to the first axial end face 12 of the ring. The raceway connecting portion 6 is located at an axial distance D2 from the first axial end face 12. The axial distance D2 may be equal to or between 14-16% of the ring width D1. The axial distance D2 may be around 15% of the ring width D1.

Further, a flange width D3 can be seen. The flange width D3 is 21-33 % of the axial distance D2 between the raceway connecting portion 6 and the first axial end face 12. The seal surface 3 can be seen to have a seal surface width D4. The seal surface width D4 is between 67-79 % of the axial distance D2 between the raceway connecting portion 6 and the first axial end face 12.

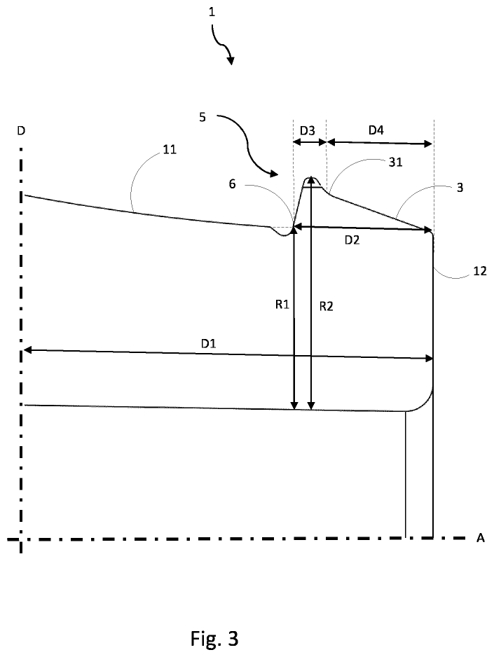

FIG. 3 is a cross-sectional view of a portion of an inner ring 1 according to an exemplary embodiment of the present disclosure. Here, the same elements as previously described for FIG. 1 and FIG. 2 can be seen, yet another example of an inner ring 1 profile can be seen that is different than that from FIG. 1 and FIG. 2. Although it looks different, the relationship between the elements, such as the first radius R1 of the connecting portion and the flange radius R2, are still the same.

To give an example of an inner ring according to an embodiment of the disclosure, an inner ring having an inner diameter (not shown) of 900 mm may have:
a ring width D1 of 258 mm,
a flange radius R2 of 520 mm,
a filling slot radius R3 (FIG. 1) of 510 mm.
a raceway connection portion 6 first radius R1 of 505 mm,
a raceway connection portion 6 axial distance D2 of 36-37 mm, preferably 36.5 mm,
a seal surface width D4 of 27-28 mm, preferably 27.5 mm, and
a flange width D3 of 8-10 mm, preferably 9 mm.

FIG. 4 is a cross-sectional view of a self-aligning roller bearing 2 (SRB) according to an exemplary embodiment of the present disclosure. Here, the self-aligning roller bearing 2 is a spherical roller bearing 2 having an outer ring 7, a cage 8, and two rows of rolling elements. The bearing 2 has a rotational center axis A, an axial center axis D, and a ring width extending to first axial end face 12 and a flange radius R2 extending to the highest point of the retaining flange 5. Further, a first axial opening 30 can be seen. The bearing 2 has a second axial opening on the opposite axial end. The other axial portion of the inner ring 1 and bearing 2 are symmetrical in this example. In this example, the outer ring 7 has two grooves on the outer ring 7 above the first axial opening 30, configured for inserting a seal 9 to reach down and seal against the seal surface 3. The bearing 2 according to the disclosure may also be provided without these grooves.

The cage 8 is of a crown type cage 8, but it could also be of any other types of cage 8. The inventors have recognized that the disclosure may be particularly suitable for spherical aligning roller bearings 2 having a crown-type cage 8, as it allows for more freedom for the rollers 4 to move and adjust their position. Therefore, to have a retaining flange radius R2 according to the disclosure becomes even more important in this case, both during operation of the bearing 2 to make sure the rollers 4 stay at the raceways 11 during misalignment of the shaft (not shown) it is intended to support, and when handling the bearing 2 during assembly/disassembly to be able to handle the bearing 2 safely without risking having the rollers 4 fall out unexpectedly.

FIG. 5 is a cross-sectional view of the self-aligning roller bearing 2 in FIG. 4, here provided with seals 9 extending from the grooves of the outer ring 7 to the seal surface 3 of the inner ring 1, thereby becoming a sealed spherical roller bearing 2 (SSRB). A benefit of the inner ring 1 design is that it can be used for both SRB and SSRB, thereby reducing complexities in production. Further, customers who first order an SRB, but then realizes an SSRB would be a better option can easily change the SRB into an SSRB. This by simply adding orbital grooves to the outer ring 7 and complement with seals 9, or simply by adding seals 9 if the grooves are already in place. No matter the option, it is a much more cost-efficient option than buying a new SSRB. This is enabled by the inner ring 1 design according to the disclosure.

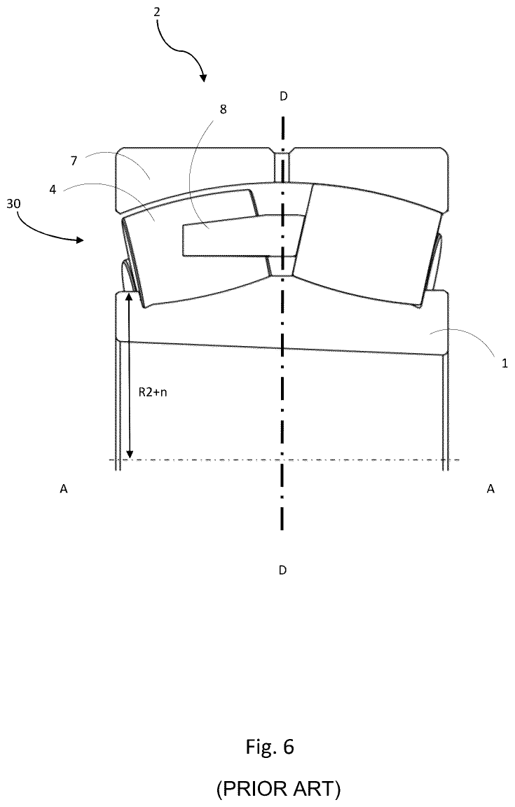

FIG. 6 is a cross-sectional view of a self-aligning roller bearing 2 according to prior art. Here an open spherical roller bearing 2 (SRB) is shown. The flange height is higher than that of the self-aligning roller bearing 2 according to the present disclosure as indicated by R2+n when measured from a rotational center axis A. For a ring having the same diameter, the flange height R2+n for an open self-aligning bearing ring according to prior art is typically 2-3 mm more than that of the inner ring according to the disclosure, as presented in FIGS. 1-3.

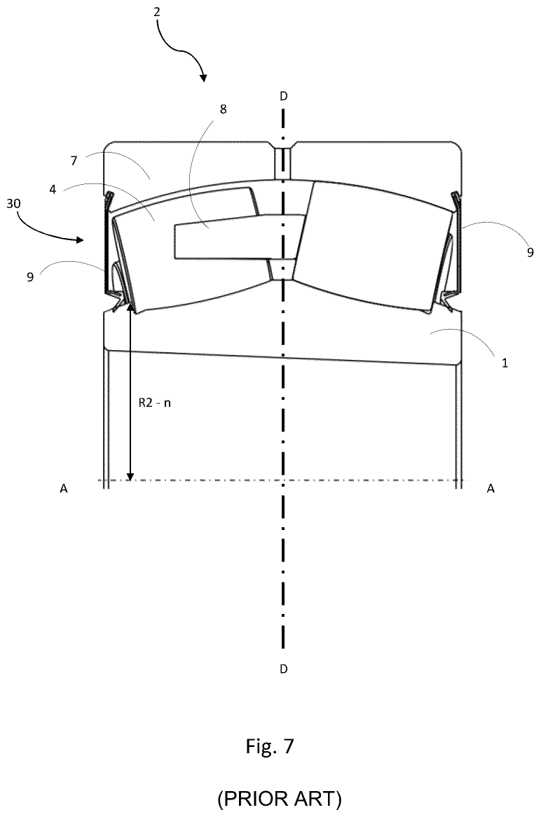

FIG. 7 is a cross-sectional view of a sealed self-aligning roller bearing 2 according to the prior art. Here a sealed spherical roller bearing 2 can be seen (SSRB). The flange height can be seen lower than that of the present disclosure as indicated by R2−n when measured from a rotational center axis A.

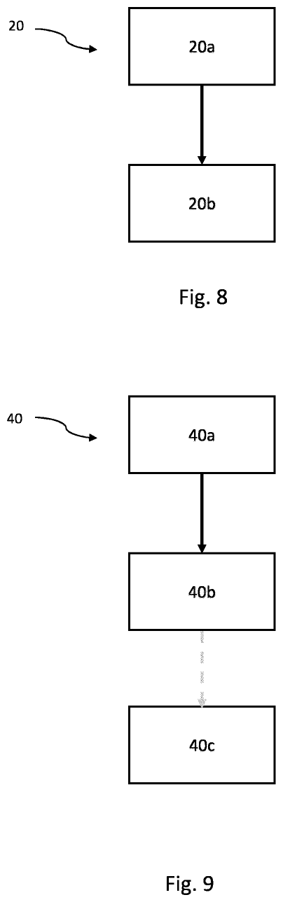

FIG. 8 depicts a flowchart of a method 20 for manufacturing an inner ring 1 according to an exemplary embodiment of the present disclosure. The method 20 comprises steps of:
providing 20a the inner ring 1, and
further providing 20b the flange width D3 being 19-35 % of the axial distance D2 of the raceway connecting portion (6), preferably 21-33 %.

The inner ring 1 and its retaining flange 5 may be provided by using manufacturing techniques such as for example, but not limited to forging, soft turning, hard turning or a combination of these techniques. A filling slot 51 may be provided by milling.

FIG. 9 is a flowchart of a method 40 for manufacturing a self-aligning roller bearing 2 according to an exemplary embodiment of the present disclosure. The flowchart of the method 40 comprising steps of:
providing 40a an outer ring 7, roller elements 4 and a cage 8 for retaining the roller elements 4,
further providing 40b an inner ring 1 according to any of the embodiments mentioned herein,
optionally providing 40c a seal 9 extending from the outer ring 7 to a seal surface 3 of the inner ring 1, thereby sealing the first axial opening 30.

The optional step of providing 40c a seal 9 is highlighted as being optional by a grey and dotted arrow, compared to the solid black arrow going from box 40a to 40b.

The optional step of providing 40c a seal 9 may include providing grooves on the outer ring 7, unless already provided. The seal 9 may be attached to grooves by also including locking ring to the groove to firmly attach the seal 9 inside the groove. The seal 9 may comprise a more solid shield part onto which a rubber seal 9 lip is attached, the rubber lip to be in sliding contact with the seal surface 3 of the inner ring 1. The seal 9 lip may be detachable from the shield part, enabling for easy substitution of the seal 9 lip in case of wear.

In an embodiment, the outer ring 7 has the features of the inner ring 1 according to the embodiments as described herein, whereas the inner ring 1 has the features of the outer ring 7 according to the embodiments as previously described herein. Thereby, the inner ring 1 would be the ring with one round raceway to take up misalignments, whereas the outer ring 7 would retain the rollers 4. In this case, the radiuses of the retaining flange 5 would be defined from a distance as measured from a distance radially outside of the bearing 2.

It is to be understood that the present disclosure is not limited to the embodiments described above and illustrated in the drawings; rather, the skilled person will recognize that many changes and modifications may be made within the scope of the appended claims.

1-11. (canceled)

12. An inner ring for a self-aligning roller bearing, the inner ring comprising:
a rotational center axis,
a raceway configured to receive roller elements,
a retaining flange at a first axial side of the raceway, the retaining flange having a flange width and being configured to prevent the roller elements from falling out from a first axial opening between the inner ring and an outer ring of a roller bearing comprising the inner ring,
a filling slot in the retaining flange configured to allow roller elements to be inserted between the inner ring and the outer ring during an assembly of the roller bearing,
a first axial end face,
a seal surface having a first end at the first axial end face and a seal surface connecting end at the retaining flange, the seal surface being configured as a counter surface for a sealing lip, and the seal surface having a seal surface width, and
a raceway connecting portion comprising the retaining flange and the seal surface, the raceway connection portion having a raceway connection portion width, and
wherein the flange width is 19-35 % of the raceway connection portion width.

13. The inner ring according to claim 12,
wherein the flange width is 21-33 % of the raceway connection portion width.

14. The inner ring according to claim 13,
wherein the seal surface width is 65-81 % of the raceway connection portion width.

15. The inner ring according to claim 13,
wherein the seal surface width is 67-79% of the raceway connection portion width.

16. The inner ring according to claim 15,
wherein an axial end of the raceway connecting portion closest to the raceway is located a first radial distance from the rotational center axis,
wherein the retaining flange is located a flange radial distance away from the rotational center axis, and
wherein the flange radial distance is 100.2% to 103.7% of the first radial distance.

17. The inner ring according to claim 15,
wherein an axial end of the raceway connecting portion closest to the raceway is located a first radial distance from the rotational center axis,
wherein the retaining flange is located a flange radial distance away from the rotational center axis, and
wherein the flange radial distance is 101% to 103% of the first radial distance.

18. The inner ring according to claim 17,
wherein the filling slot is a semicircular cutout extending from a top surface of the retaining flange,
wherein a portion of the filling slot closest to the rotational center axis is located a filling slot radial distance away from the rotational center axis, and
wherein the filling slot radial distance is 100.1% to 103.5% of the first radial distance.

19. The inner ring according to claim 18,
wherein the inner ring is divided by an axial center plane,
wherein a shortest distance from the axial center plane to the first axial end face is a ring half width, and
and wherein the raceway connecting portion width is 14% to 16% of the ring half width.

20. The inner ring according to claim 18,
wherein the inner ring is divided by an axial center plane,
wherein a shortest distance from the axial center plane to the first axial end face is a ring half width, and
and wherein the raceway connecting portion width is 15% of the ring half width.

21. A self-aligning roller bearing comprising:
an inner ring according to claim 12,
an outer ring located radially outside of the inner ring, the inner and outer ring defining a first axial opening therebetween, and
a bearing cage between the inner ring and the outer ring,
wherein the roller elements are mounted in the bearing cage.

22. The self-aligning roller bearing according to claim 21, wherein the cage is a crown cage.

23. The self-aligning roller bearing according to claim 21,
wherein the self-aligning roller bearing includes a seal extending from the outer ring to the seal surface.
